(19) United States
(12) Patent Application Publication
(10) Pub. No.: US 2026/0227037 A1
(43) Pub. Date: Aug. 6, 2026

(54) INJECTION QUILL DEVICE

(71) Applicant: BOHR LIMITED, Stone, Staffordshire (GB)

(72) Inventors: Jack Edward Knight, Shrewsbury, Shropshire (GB); Jeremy KNIGHT, Shrewsbury, Shropshire (GB)

(21) Appl. No.: 19/149,261

(22) PCT Filed: Jan. 17, 2024
(86) PCT No.: PCT/GB2024/050129

§ 371 Date: Jul. 18, 2025

(30) Foreign Application Priority Data
Jan. 19, 2023 (GB) GB2300811.3

(51) Int. Cl. F17D 3/12; B01F 25/00; B01F 25/313

(52) U.S. Cl. CPC F17D 3/12; B01F 25/31331; B01F 2025/919121; B01F 2025/93

(57) ABSTRACT

An injection quill device is provided for fluid delivery into a pipeline. The injection quill device comprises an elongate device body having an outer surface comprising an in-use upstream portion and an in-use downstream portion, and an injection bore having a plurality of injection apertures spaced along a longitudinal extent of the elongate device body. There are fluid-flow directing elements on the elongate device body to disrupt flow downstream of the plurality of injection apertures.

### RELATED APPLICATIONS

This application is based on prior filed copending International Application No. PCT/GB2024/050129 filed Jan. 17, 2024, which claims priority to Great Britain Application No. 2300811.3, filed Jan. 19, 2023, the entire subject matter of these applications is incorporated herein by reference in its entirety.

### TECHNICAL FIELD

The present invention relates to an injection quill device, preferably but not exclusively for introduction of a fluid in a pipeline.

### BACKGROUND

Injection quill devices are used to introduce additives, typically fluids, into fluid pipelines, such as gas pipelines. Typically, they are mounted perpendicular to the main fluid flow in the fluid pipeline.

As fluid is injected, it enters into the main flow of the pipeline. However, given the flow rate in pipelines, the additive is often poorly mixed, and the content of the fluid within the pipeline has high and low regions of additive content.

Furthermore, fluid flow velocity in a gas pipeline varies across the diameter of the pipe. The velocity of the fluid in the pipeline is greatest at the centre of the pipe, and decreases towards the pipe walls. This provides challenges for uniformly dosing the fluid in the pipeline with additives.

Injection quill devices may well find a use in injection of hydrogen gas into existing gas networks. It is therefore highly undesirable if there is a non-uniform distribution of injected hydrogen within the pipeline, as this could be deleterious to the use in mixed-gas burners.

Sampling may also occur just downstream of injection devices, and if there is inadequate homogenisation of the injected fluid, then the sample readings will be incorrect.

It is an object of the invention to provide an injection quill device capable of overcoming the above-referenced limitations.

### SUMMARY

According to a first aspect of the invention, there is provided an injection quill device for fluid delivery into a pipeline, the injection quill device comprising: an elongate device body having an outer surface comprising an in-use upstream portion and an in-use downstream portion; an injection bore having a plurality of injection apertures spaced along a longitudinal extent of the elongate device body; and a plurality of fluid-flow-directing elements is positioned on the outer surface of the elongate device body for in-use disrupting a fluid flow downstream of the plurality of injection apertures.

Ensuring improved mixing of injected fluid into a pipeline is achieved by the provision of fluid-flow-directing elements on the surface of the injection quill device, increasing downstream turbulence, and churning the injected fluid into the main flow. Additional advantages of the present device include that it is insertable perpendicularly or substantially perpendicularly to the pipeline, and therefore minimal longitudinal length of pipeline is required to be able to attach the device thereto. The presence of the fluid-flow-directing elements also means that the device can span the majority of the pipe diameter, allowing the injection quill device to be inserted further into or even right across the pipeline with minimal risk of vortex-induced vibrations impacting on the injection quill device.

At least some of the plurality of injection apertures may have different dimensions to one another to provide a non-uniform fluid delivery along the longitudinal extent of the in-use upstream portion and/or the in-use downstream portion.

By providing different injection aperture dimensions for the injection quill, a graded injection capacity can be achieved across the diameter of a pipe of, for example, a gas network pipeline. This can lead to uniformity of injection.

Optionally, the dimensions of the plurality of injection apertures may decrease towards the respective ends of the elongate device body.

Since the fluid flow velocity is greatest in the centre of a pipe, it stands to reason that the largest aperture should be coincident with the centre of the pipe, and that the apertures extending in either direction should decrease in size.

Preferably, the dimensions of the plurality of injection apertures may be symmetric about a longitudinal midpoint of the elongate device body.

Symmetry of aperture size ensures that, for a circular pipe at least, the injection flow should be broadly matching with the change in flow velocity across the pipe, which changes as a function of distance to the pipe walls.

Preferably, the dimensions of the plurality of injection apertures may vary along the longitudinal extent of the in-use upstream portion and/or the in-use downstream portion according to a normal distribution.

Since there is a broadly normal distribution of velocities within the pipeline, peaking at the centreline of the pipe, the dimensioning of the injection apertures can be made accordingly.

Optionally, the plurality of injection apertures may be non-uniformly spaced apart along the longitudinal extent of in-use upstream portion and/or the in-use downstream portion. A spacing between each of the plurality of injection apertures may increase towards the respective ends of the elongate device body.

An alternative means of altering the proportion of injected fluid closer to a centre-line of the pipe is to decrease a separation between the injection apertures closer to the central pipe axis. This achieves a similar end to dimensionally altering the injection apertures.

In one embodiment, the plurality of injection apertures may be spaced along the longitudinal extent of in-use upstream portion and/or the in-use downstream portion are co-axial with one another.

In the preferred arrangement, the apertures are positioned either to face upstream or downstream, to release injected fluid directly into the main flow in the pipe.

Additionally, or alternatively, the plurality of injection apertures may be perimetrically offset relative to the in-use upstream portion and/or the in-use downstream portion.

It may be possible to inject fluid from the sides of the device body, as an alternative to direct injection into the flow.

Furthermore, the plurality of injection apertures may be perimetrically staggered around the outer surface of the elongate device body.

Injection apertures may be positioned anywhere on the outer surface of the device body, since flow disruption is occurring downstream of the device body regardless of where the point of injection occurs.

Optionally, the plurality of injection apertures may be uniformly spaced apart along the longitudinal extent of in-use upstream portion and/or the in-use downstream portion.

Uniform spacing of the apertures assists with uniform injection, though a similar effect could be achieved by clustering of apertures towards regions of high fluid flow of the pipe.

Optionally, the elongate device body may be dimensioned to be approximately equal to a diameter of a pipeline into which the injection quill device is to be inserted.

In order to dose the fluid in the pipe uniformly, it is anticipated that the injection quill device have a length close to that of the pipe diameter.

The plurality of fluid-flow-directing elements may be perimetrically offset to both the upstream portion and the downstream portion of the elongate device body.

The provision of the fluid-flow directing elements on the elongate device body reduces the effects of coherent vortex shedding on the device, reducing the need to provide additional stabilisation in the pipeline, whilst also increasing granular turbulence.

A perimetric dimension of the upstream portion and/or the downstream portion may be less than 20% of the perimetric extent of the elongate device body, less than 15% of the perimetric extent of the elongate device body, less than 10% of the perimetric extent of the elongate device, or less than 5% of the perimetric extent of the elongate device body.

The aim of the invention to create downstream turbulence for improved mixing of injected fluid, and greater mixing effects may be created by a larger expanse of fluid-flow-directing elements across the surface of the elongate device body.

Optionally, a perimetric dimension of the upstream portion may be greater than, less than, or equal to a perimetric extent of the downstream portion.

As such, it is preferred that the upstream portion devoid of fluid-flow-directing elements be at least as large, if not larger, than the downstream portion to reduce disturbance in the upstream region. However, the reverse may be true.

Preferably, at least one first fluid-flow-directing element of the plurality of said fluid-flow-directing elements may be positioned on a left-hand lateral-facing portion of the elongate device body, and at least one second fluid-flow-directing element of the plurality of said fluid-flow-directing elements is positioned on a right-hand lateral-facing portion of the elongate device body.

It will be appreciated that flow can be diverted around either side of the upstream portion of the elongate device body, and therefore having fluid-flow-directing elements on both sides of the device is clearly advantageous.

The at least one first fluid-flow-directing element of the plurality of fluid-flow-directing elements may be linearly or rotationally asymmetrically positioned with respect to the at least one second fluid-flow-directing element of the plurality of fluid-flow-directing elements.

Optionally, the at least one first fluid-flow-directing element of the plurality of fluid-flow-directing elements may direct fluid in a first at least in part vertical direction, and the at least one first fluid-flow-directing element of the plurality of fluid-flow-directing elements direct fluid in a second at least in part vertical direction which is different to the first at least in part vertical direction.

Asymmetry of the flow diversion may be helpful for creating the correct sort of turbulence on the downstream side of the device. This could be achieved by inserting helices of different screw directions on either side of the device, for instance.

The lateral-facing portions have a perimetric dimension which is at least 10% of the perimetric extent of the elongate device body, at least 20% of the perimetric extent of the elongate device body, at least 25% of the perimetric extent of the elongate device body, at least 50% of the perimetric extent of the elongate device body, or at least 75% of the perimetric extent of the elongate device body.

There will be a minimum perimetric or circumferential span of the fluid-flow-directing elements which creates sufficient granular turbulence for mixing, without impinging on the operational capacity of the device.

Segmentation of the device into quarters, that is, upstream, left, downstream, and right portions does appear to provide a suitable balance between these competing factors. However, the greater the amount of fluid-flow-directing elements, the greater the potential for creating the granular turbulence.

Preferably, a cross-section of the elongate probe body is or is substantially: cylindrical; square; hexagonal; or otherwise geometrically uniform or regular.

Many device shapes are feasible, and the only crucial criteria is that there not be significant flow disruption to the fluid in the pipeline.

Optionally, the upstream portion may be at least in part concave; convex; or flat.

Different device body shapes may have different useful flow disruption properties when inserted into a pipeline.

### BRIEF DESCRIPTION OF THE DRAWINGS

The invention will now be more particularly described, by way of example only, with reference to the accompanying drawings, in which:

FIG. 1 shows a front perspective representation of a first embodiment of an injection quill device in accordance with the first aspect of the invention;

FIG. 2 shows a front view of the injection quill device of FIG. 1;

FIG. 3A shows the injection quill device of FIG. 1 configured to inject fluid sample in an upstream direction of fluid flow in a pipeline; and

FIG. 3B shows the injection quill device of FIG. 1 configured to inject fluid sample in a downstream direction of fluid flow in a pipeline.

### DETAILED DESCRIPTION

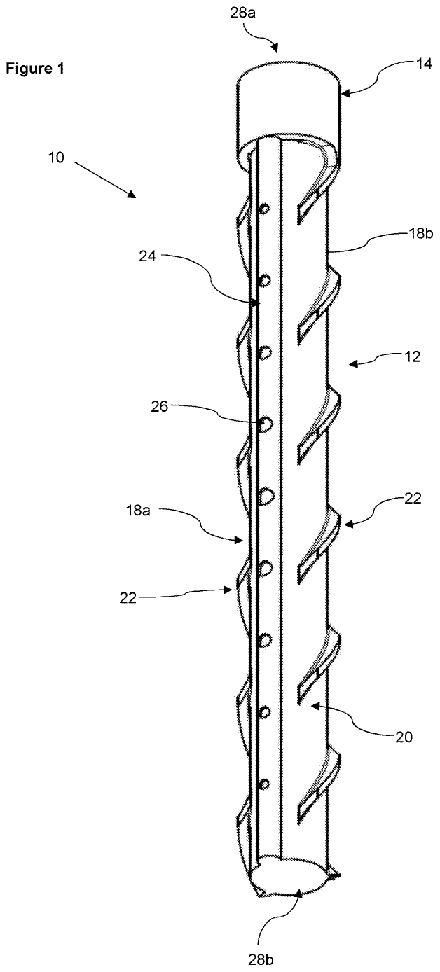

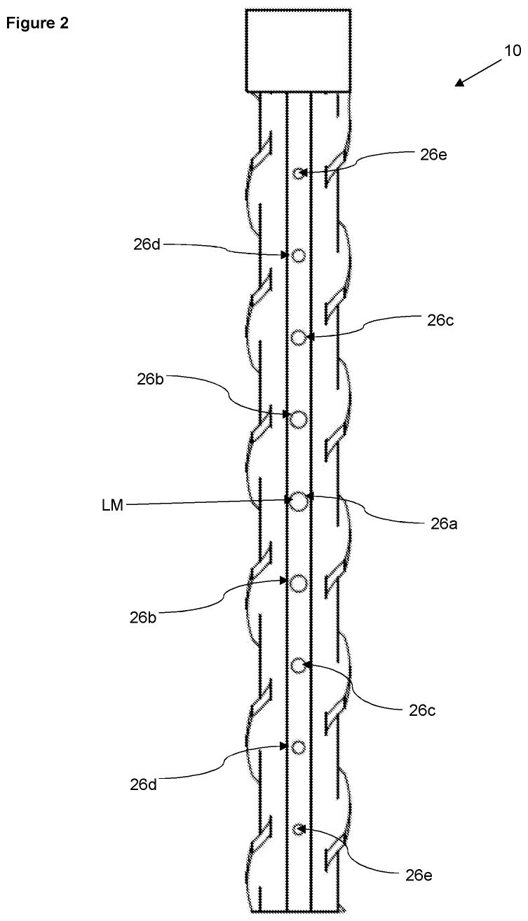

Referring firstly to FIGS. 1 and 2 there is shown an injection quill device, referenced globally at 10 and which is suitable for injecting fluid into a moving fluid source, such as a natural gas pipeline.

The injection quill device 10 comprises an elongate device body 12 which is designed to be inserted into the flow of the fluid, perpendicular or substantially perpendicular to a direction of flow of the said fluid being transported. At one end of the elongate device body 12 there is provided a head portion 14 which allows for coupling of the injection quill device 10 to onward a fluid source.

An in-use upstream portion 18a and in-use downstream portion 18b can be defined as the portions of an outer surface 20 of the elongate device body 12 which face towards or away from the fluid flow in the pipeline, in use.

The terms perimetric and circumferential are used interchangeably here. Whilst the elongate device body 12 illustrated is cylindrical, and therefore the term circumference is appropriate, it will be apparent that any divergence from a cylindrical shape would render this terminology inconsistent. Examples of other shapes include; square; hexagonal; or otherwise uniform or regular geometric shapes.

Extending from the outer surface 20 of the elongate device body 12 is a plurality of fluid-flow-directing elements 22, located between the in-use upstream portion 18a and in-use downstream portion 18b, so as to be perimetrically offset therefrom. In other words, the fluid-flow-directing elements 22 do not extend into the in-use upstream portion 18a and in-use downstream portion 18b.

The fluid-flow-directing elements 22 may be formed as baffles, strakes, or fins, which have a rectilinear or substantially rectilinear cross section. A plurality of the fluid-flow-directing elements 22 are provided in a spaced-apart manner on each side of the in-use upstream portion 18a and in-use downstream portion 18b. It is therefore possible to define left-and right-hand sides of the elongate device body 12 by reference to the areas in which the fluid-flow-directing elements 22 are present. Whilst the fluid-flow-directing elements 22 are shown extending along the length of the elongate device body 12, they may be positioned only on part thereof.

The fluid-flow-directing elements 22 of the left-and right-hand sides may be staggered relative to one another in a vertical direction. The fluid-flow-directing elements 22 of the left-and right-hand sides may additionally or alternatively have fluid-directing surfaces which direct the fluid flowing thereacross which are oriented in different vertical directions.

Whilst the fluid-flow-directing elements 22 may be rectilinear or substantially rectilinear in cross section when viewed from the left-and right-hand sides respectively, the curvature of the outer surface 20 of the elongate device body 12 is such that leading and/or trailing edges of the fluid-flow-directing elements 22 may not themselves be rectilinear.

A perimetric dimension of the upstream portion and/or the downstream portion 18 a, 18 b may be less than 20% of the perimetric extent of the elongate device body 12, may be less than 15% of the perimetric extent of the elongate device body 12, less than 10% of the perimetric extent of the elongate device 12, or less than 5% of the perimetric extent of the elongate device body 12. The lateral-facing portions between the upstream portion and the downstream portion 18a, 18b have a perimetric dimension which is at least 10% of the perimetric extent of the elongate device body 12, at least 20% of the perimetric extent of the elongate device body 12, at least 25% of the perimetric extent of the elongate device body, at least 50% of the perimetric extent of the elongate device body 12, or at least 75% of the perimetric extent of the elongate device body 12. In other words, the greater the amount of outer surface 20 given to fluid-flow-directing elements 22, the better.

The fluid-flow-directing elements 22 shown are only illustrative embodiments. The fluid-flow-directing elements could be formed so as not to be staggered on the left-and right-hand sides. The fluid-flow-directing elements could be formed so as to direct flow on the left-and right-hand sides in the same vertical or axial direction, rather than in opposite vertical directions as illustrated. The fluid-flow-directing elements could be formed so as to not have a rectilinear cross-section, and could instead have a more traditional thin blade configuration, or may form interrupted helical strakes. Any appropriate shape or form of fluid-flow directing element could be provided without diverting from the scope of the present invention. For instance, complete helices could be used, as could vertically-oriented or horizontally-oriented strakes.

A channel 24 is provided on one side of the elongate device body 12, having an injection bore therein via which fluid can be inserted into an associated pipeline.

There is a plurality of injection apertures 26 which are positioned on the outside of the channel 24, and which are suitable for dispensing fluid therefrom.

The plurality of injection apertures 26 are dimensioned so as to decrease in size, be it width or diameter, towards the respective ends 28a, 28b of the elongate device body 12. It will be appreciated that the fluid-flow-directing elements could be completely removed, and a device constructed in which only the change in aperture size or number of apertures was variable along the length of the elongate device body 12 which was less concerned about creating granular turbulence.

It can also be seen that the dimensions of the plurality of injection apertures 26 is symmetric about a longitudinal midpoint LM of the elongate device body 12. The dimensioning is shown as having a normal or substantially normal distribution The plurality of injection apertures 26 are uniformly spaced apart along the longitudinal extent of in-use upstream portion 18a and/or the in-use downstream portion 18b for consistent injection capabilities.

The largest injection aperture 26a is positioned on the longitudinal midpoint LM, or close thereto, with the dimensions of the injection apertures 26b, 26c, 26d, 26e decreasing towards the ends 28a, 28b of the elongate device body 12.

It is preferred that the elongate device body 12 is dimensioned to be approximately equal to a diameter of a pipeline into which the injection quill device 10 is to be inserted. In this manner, the largest injection apertures 26 are positioned close to the centre of the flow in the pipe.

Doing so ensures that the aperture configuration shown is proportionate to the flow in the pipeline, and fluid injection occurs at an appropriate level.

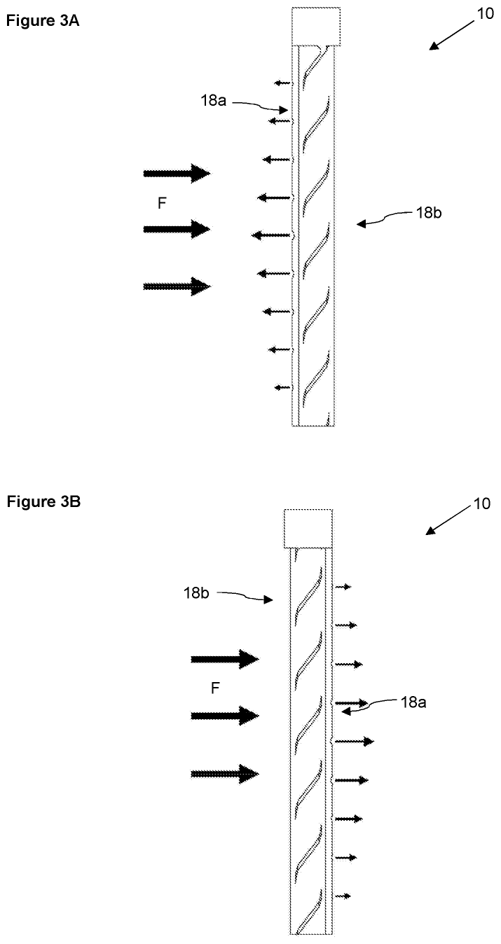

FIGS. 3A and 3B show two potential injection quill device 10 orientations within a pipeline, with the arrows F showing the direction of fluid flow within the pipe.

FIG. 3A shows an upstream injection configuration in which the plurality of injection apertures 26 are directed into the oncoming fluid flow F. Either arrangement is feasible, though it will be appreciated that the terms in-use upstream portion 18a and in-use downstream portion 18b of the elongate device body 12 will be determined by the injection quill device's orientation with respect to the flow, rather than being an intrinsic feature of the elongate device body 12 out of the flow. Regardless of the orientation, however, it is clear that the turbulence generated by the fluid-flow-directing elements 22 will be downstream of the plurality of injection apertures 26, i.e., to the right-hand-side in each diagram.

The injection quill herebefore described has injection apertures 26 on the in-use upstream and/or downstream portions 18a, 18b respectively. However, since turbulent flow is created by the fluid-flow-directing elements 22 directly, the point of injection could be from the sides of the elongate body, for instance. Alternatively, the plurality of apertures could be positioned around the outer surface of the elongate device body in a staggered manner, so that the plurality of apertures are perimetrically spaced from one another. This is the case where there are both upstream and downstream apertures, however, could be provided in conjunction with side apertures, positioned at any angle relative to the fluid flow direction.

Whilst not illustrated, it will be appreciated that the injection quill device will be provided with a pipeline connector for mounting to a pipeline, such as a flange or cap connector. It may be feasible to construct the pipeline connector having the injection quill device movably attached thereto, so that the injection quill device can be retracted relative to the pipe. This allows the injection quill device to be retrofitted to the pipeline without shutting down the main flow of the pipeline, since installation can occur without need to penetrate into the main pipeline initially.

Whilst alteration of the dimensions of the injection apertures towards the centre of the elongate probe device, to mirror the dimensions of the pipe, is one way of achieving flow-proportional injection, it will be appreciated that a similar effect could be achieved by non-uniform spacing of the injection apertures. In particular this could be achieved by an increased spacing towards the extremities of the elongate probe device, such that there were greater clusters of injection apertures towards the centre.

It is therefore possible to provide an injection quill device capable of injecting an additive into a gas pipeline in a uniform manner, which may correspond broadly with the fluid flow velocity within the pipeline. This can be used for upstream injection or downstream injection. The provision of fluid-flow-directing elements thereon disrupts the flow downstream of the device, thereby improving mixing of the injected fluid into the main pipe flow.

The words ‘comprises/comprising’ and the words ‘having/including’ when used herein with reference to the present invention are used to specify the presence of stated features, integers, steps, or components, but do not preclude the presence or addition of one or more other features, integers, steps, components, or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. An injection quill device for fluid delivery into a pipeline, the injection quill device comprising:
an elongate device body having an outer surface comprising an in-use upstream portion and an in-use downstream portion;
an injection bore having a plurality of injection apertures spaced along a longitudinal extent of the elongate device body; and
a plurality of fluid-flow-directing elements is positioned on the outer surface of the elongate device body for in-use disrupting a fluid flow downstream of the plurality of injection apertures.

2. An injection quill device as claimed in claim 1, wherein at least some of the plurality of injection apertures have different dimensions to one another to provide a non-uniform fluid delivery along the longitudinal extent of the in-use upstream portion and/or the in-use downstream portion.

3. An injection quill device as claimed in claim 2, wherein the dimensions of the plurality of injection apertures decreases towards the respective ends of the elongate device body.

4. An injection quill device (10) as claimed in claim 2, wherein the dimensions of the plurality of injection apertures is symmetric about a longitudinal midpoint of the elongate device body.

5. An injection quill device as claimed in any one of claim 2, wherein the dimensions of the plurality of injection apertures vary along the longitudinal extent of the in-use upstream portion and/or the in-use downstream portion according to a normal distribution.

6. An injection quill device as claimed in claim, wherein the plurality of injection apertures are uniformly spaced apart along the longitudinal extent of in-use upstream portion and/or the in-use downstream portion.

7. An injection quill device as claimed in claim 1, wherein the plurality of injection apertures are non-uniformly spaced apart along the longitudinal extent of in-use upstream portion and/or the in-use downstream portion.

8. An injection quill device as claimed in claim 7, wherein a spacing between each of the plurality of injection apertures increases towards the respective ends of the elongate device body.

9. An injection quill device as claimed in claim 1, wherein the plurality of injection apertures are spaced along the longitudinal extent of in-use upstream portion and/or are spaced along the in-use downstream portion so as to be co-axial with one another.

10. An injection quill device as claimed in claim 1, wherein the plurality of injection apertures are perimetrically offset relative to the in-use upstream portion and/or the in-use downstream portion and/or the plurality of injection apertures are perimetrically staggered around the outer surface of the elongate device body.

11. (canceled)

12. An injection quill device as claimed in any one of the preceding claim 1, wherein the elongate device body is dimensioned to be approximately equal to a diameter of a pipeline into which the injection quill device is to be inserted.

13. An injection quill device as claimed in claim 1, wherein the plurality of fluid-flow-directing elements are perimetrically offset to both the upstream portion and the downstream portion of the elongate device body.

14. An injection quill device as claimed in claim 13, wherein a perimetric dimension of the upstream portion and/or the downstream portion is less than 20% of the perimetric extent of the elongate device body, optionally less than 15% of the perimetric extent of the elongate device body, preferably less than 10% of the perimetric extent of the elongate device, and more preferably less than 5% of the perimetric extent of the elongate device body.

15. (canceled)

16. (canceled)

17. (canceled)

18. An injection quill device as claimed in any one of claim 13, wherein a perimetric dimension of the upstream portion is greater than or equal to a perimetric extent of the downstream portion.

19. An injection quill device as claimed in any one of claim 13, wherein at least one first fluid-flow-directing element of the plurality of said fluid-flow-directing elements is positioned on a left-hand lateral-facing portion of the elongate device body, and at least one second fluid-flow-directing element of the plurality of said fluid-flow-directing elements is positioned on a right-hand lateral-facing portion of the elongate device body.

20. An injection quill device as claimed in claim 19, wherein the at least one first fluid-flow-directing element of the plurality of fluid-flow-directing elements is linearly or rotationally asymmetrically positioned with respect to the at least one second fluid-flow-directing element of the plurality of fluid-flow-directing elements.

21. An injection quill device as claimed in claim 20, wherein the at least one first fluid-flow-directing element of the plurality of fluid-flow-directing elements direct fluid in a first at least in part vertical direction, and the at least one second fluid-flow-directing element of the plurality of fluid-flow-directing elements direct fluid in a second at least in part vertical direction which is different to the first at least in part vertical direction.

22. An injection quill device as claimed in any one of claims wherein the lateral-facing portions have a perimetric dimension which is at least 10% of the perimetric extent of the elongate device body, optionally at least 20% of the perimetric extent of the elongate device body, optionally at least 25% of the perimetric extent of the elongate device body, preferably at least 50% of the perimetric extent of the elongate device body, and more preferably, at least 75% of the perimetric extent of the elongate device body.

23. (canceled)

24. (canceled)

25. (canceled)

26. (canceled)

27. An injection quill device as claimed in claims 1, wherein a cross-section of the elongate device body is any one of cylindrical; square; hexagonal; and otherwise geometrically uniform or regular.

28. An injection quill device as claimed in claims 1, wherein the upstream portion is at least in part concave; convex; or flat.
